(19) United States
(12) Patent Application Publication
(10) Pub. No.: US 2006/0094510 A1
(43) Pub. Date: May 4, 2006

(54) Visual barrier for partitioning a viewing area

(76) Inventors: Marcus Luis Risso, Manhattan Beach, CA (US); Eric Wayne La Flamme, Newcastle, CA (US)

Correspondence Address: Marcus Risso, 4418 Ocean Dr., Manhattan Beach, CA, 90266, US

(21) Appl. No.: 11/253,921

(22) Filed: Oct. 19, 2005

Related U.S. Application Data
(60) Provisional application No. 60/620,431, filed on Oct. 19, 2004.

(51) Int. Cl. A63F 9/24; H04N 5/72

(52) U.S. Cl. 463/46; 348/832

(57) ABSTRACT

The present invention relates to a visual barrier for partitioning a viewing area of a television into at least two sides, comprising a visual partition configured to partition a viewing area of a television. The visual partition can be formed in a number of configurations. For example, the visual partition can be a substantially planar board that is placed in front of the view area, it can be a plurality of extending members with extendable partitioning members extending therefrom, and it can be formed of a material that includes at least two planes of polarization.

### PRIORITY CLAIM

The present application is a non-provisional patent application, claiming the benefit of priority of U.S. Provisional Patent Application No. 60/620,431, filed on Oct. 19, 2004, entitled, “Visual Barrier.”

### FIELD OF INVENTION

The present invention relates to a visual barrier, and more particularly, to a visual barrier that partitions a viewing area of a television surface into at least two sides.

### BACKGROUND OF INVENTION

Home gaming has become increasingly popular. As home gaming has become more sophisticated, a myriad of multi-player games have emerged. For example, multiple users may play a football game on their home television set, with each user having a portion of the television being dedicated to their individual game play, e.g., split screens with one screen being dedicated to the offensive player while the other screen is dedicated to the defensive player. A problem emerges however when the multiple players are playing competitively against one another.

As shown in FIG. 1, each gamer is dedicated their own portion of the television 100 screen 101. The first gamers 102 game play is typically shown on split screen side A 104, while the second gamers 106 game play is typically shown on split screen side B 108. The problem however is that while playing, it may be advantageous to see their competitors screen play, but disadvantageous to their own gaming because their competitor can see their own screen play. For example, while competing against the second gamer 106, the first gamer 102 can view split screen side B 108. Alternatively, the second gamer 106 can view split screen side A 104.

Therefore, it can be appreciated that there exists a continuing need for a new and improved visual barrier for separating a viewing area of a television surface. In this regard, the present invention substantially fulfills this need.

### SUMMARY OF THE INVENTION

The present invention relates to a visual barrier for partitioning a viewing area of a television into at least two sides. The visual barrier comprises a visual partition. The visual partition is formed to attach with a television and to partition a viewing area of a television, whereby when attached with the television, the viewing area of the television is split into at least two sides.

The present invention further comprises a base attached with the visual partition. The base is formed to be attached with a television and to hold the visual barrier as a partition of the viewing area of the television. The base further comprises a holding apparatus to hold the visual partition.

In another aspect, the base further comprises an extending apparatus, such that the visual partition can be extended away from the viewing area.

In yet another aspect, the base further comprises a swivel apparatus, such that the visual partition can be extended away and swiveled from the viewing area.

In yet another aspect, the base further comprises an attachment apparatus for attaching with a television. The attachment apparatus is selected from a group consisting of suction cups, clamps, Velcro, screws, glue, and counter weight.

In another aspect, the visual partition further comprises visuals. The visuals are selected from a group consisting of advertisements, game relative visuals, instructions, and game tips.

Additionally, the visual partition is included along with a game system's packaging, such that the visual partition can be removed from the packaging and used as the visual barrier.

In another aspect, both the visual partition and the base are substantially planar.

In yet another aspect, both the visual partition and the base have slots therein such that the two can be connected with each other through the slots.

In another aspect, the visual partition further comprises a plurality of extending members. The plurality of extending members further include a plurality of extendable partitioning members, such that the plurality of extending members can be extended from the base, with the plurality of partitioning members being extendable down therefrom.

In another aspect, the visual partition is formed of a polarizing material and is formed such that the visual partition includes at least two planes of polarization, such that a first user aligned with a first plane of polarization can view a first gaming surface, while a second user aligned with a second plane of polarization can view a second gaming surface. The at least two planes of polarization are formed of optical isomers.

Finally, as can be appreciated by one skilled in the art, the present invention further comprises a method for forming the visual barrier. The method comprises acts of forming and connected the respective components described herein.

### BRIEF DESCRIPTION OF THE DRAWINGS

The nature of the visual barrier described herein will be readily apparent in the following drawings, in which:

FIG. 1 is an illustration of a television with a split screen;

FIG. 2 is an illustration of a television with a visual barrier attached to it according to the present invention;

FIG. 3 is an illustration of another aspect of the visual barrier according to the present invention;

FIG. 4 is an illustration of the visual barrier of FIG. 3, in an extended position;

FIG. 5 is an illustration of a visual barrier according to the present invention;

FIG. 6 is an illustration of a package with visuals printed thereon for use with the visual barrier;

FIG. 7 is an illustration of another aspect of a visual barrier according to the present invention;

FIG. 8 is an illustration of yet another aspect of a visual barrier according to the present invention;

FIG. 9 is an illustration of a further aspect of a visual barrier according to the present invention;

FIG. 10 is yet another aspect of a visual barrier according to the present invention;

FIG. 11 is yet another aspect of a visual barrier according to the present invention;

FIG. 12 is a bottom view of the visual barrier of FIG. 11;

FIG. 13 is a front view of the visual barrier of FIG. 11;

FIG. 14 is a cut-away side view of the visual barrier of FIG. 11, in a collapsed position;

FIG. 15 is a cut-away side view of the visual barrier of FIG. 11, in an expanded position;

FIG. 16 is a perspective view of the visual barrier of FIG. 11, positioned atop a television;

FIG. 16 is a perspective view of the visual barrier of FIG. 15, in an expanded position;

FIG. 17 is perspective view of the visual barrier of FIG. 16;

FIG. 18 is perspective view of the visual barrier of FIG. 16 in a fully expanded position;

FIG. 19A is an illustration of a visual barrier including optical isomers to form different planes of polarization according the present invention; and

FIG. 19B is an illustration of the visual barrier of FIG. 18A, attached with a television.

### DETAILED DESCRIPTION

The present invention relates to a visual barrier, and more particularly, to a visual barrier that partitions a viewing area of a television surface into at least two sides. The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

(1) Introduction

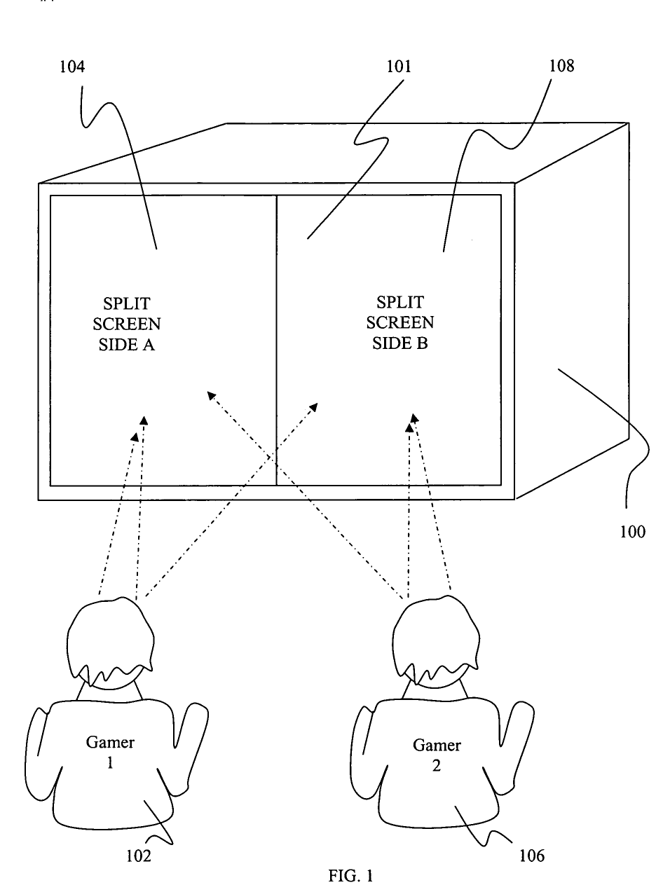

Many home-operated video games are now equipped with split-screen gaming, allowing a plurality of gamers to play simultaneously. By splitting the screen, each individual gamer can control the environment in their particular screen. However, as shown in FIG. 1, traditional split-screen operation allows a first gamer 102 to view a second gamer's 106 split-screen 108. Through viewing another gamer's split screen, the gamer is unfairly benefited by being able to view the other gamer's operations and environment. Conversely, the second gamer 106 is unfairly benefited by being able to view the first gamer's 104 split screen.

(2) Discussion of Various Aspects

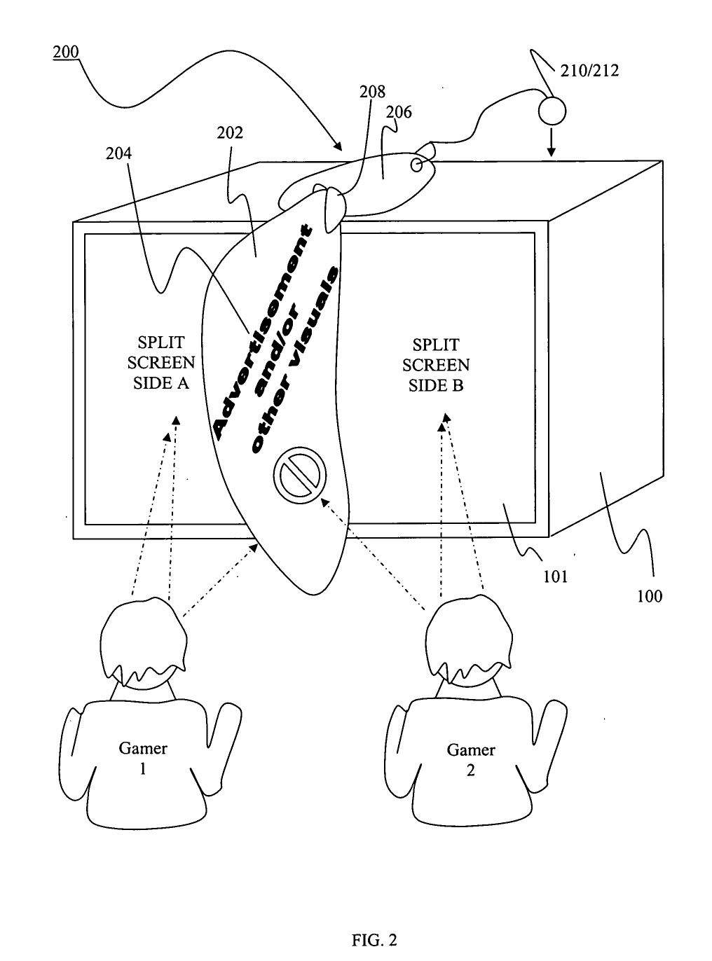

The present invention was devised to solve the problems of split screen gaming. In order to prevent a gamer from seeing the other gamer's screen, the present invention discloses a visual barrier 200 as shown in FIG. 2. The visual barrier 200 includes a visual partition 202 that is formed in any suitable manner such that it divides the television screen 101 into at least two viewing areas and aids in preventing at least two gamers from seeing each others' gaming areas. Non-limiting examples of visual partitions 202 include a substantially planar board that is placed in front of the view area, a plurality of extending members with extendable partitioning members extending therefrom, and being formed of a material that includes at least two planes of polarization. Additionally, the visual barrier can include visuals 204. The visual barrier includes any suitable visuals, non-limiting examples of which include advertisements, game relative visuals, instructions, and game tips. For example, if the game was a video game, the game relative visuals may include street screens and road signs.

Additionally, the visual barrier 200 may optionally include a base 206. The base 206 is formed in any matter such that it aids in attaching the visual barrier 200 with a television 100. For example, the base 206 may include a holding apparatus 208 to attach the visual partition 202 with the base 206. The holding apparatus 208 is any suitable mechanism or device for holding an object in place, non-limiting examples of which include glue, staples, clamps, clips, Velcro, etc. Additionally, the base 206 may optionally include an attachment apparatus 210. The attachment apparatus 210 is any suitable mechanism or device for attaching the base 206 with a television 100, non-limiting examples of which include suction cups, clamps, Velcro, screws, glue, and a counter weight 212.

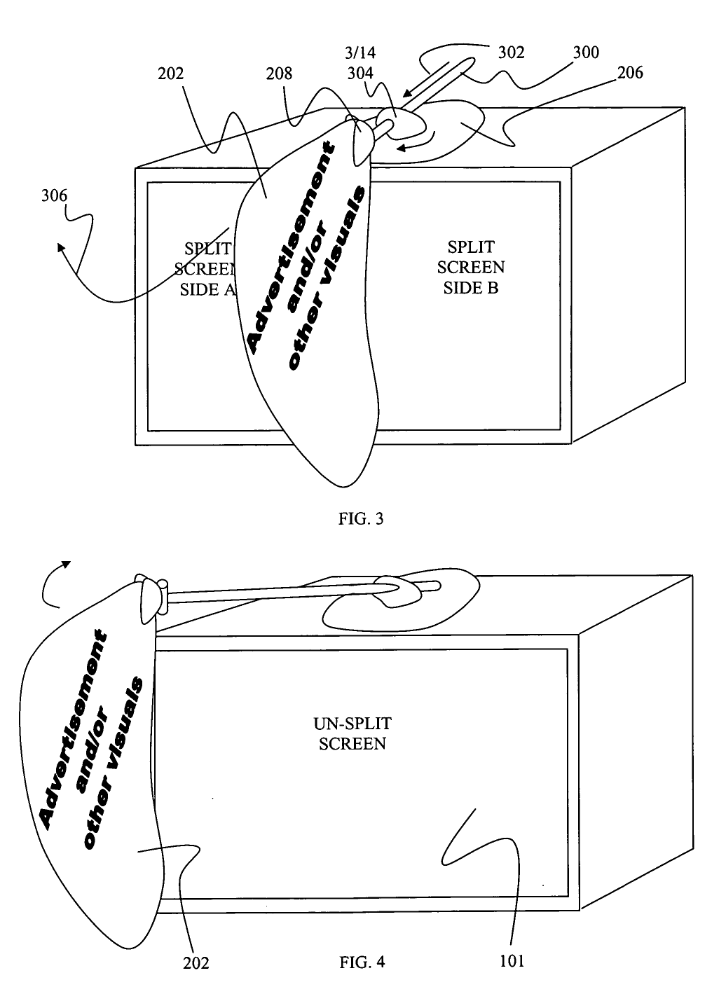

As shown in FIG. 3, the base 206 can be formed in a variety of forms. For example, the base 206 can be formed such that it includes a holding apparatus 208 to hold the visual partition 202. The base may further include an extending apparatus 300, such that the visual partition 202 can be extended away 302 from the viewing area. The extending apparatus is any mechanism or device for extending the visual partition 202 away 302 from the viewing area, a non-limiting example of which includes an extending rod. Additionally, the base further comprises a swivel apparatus 304, such that the visual partition 202 can be extended away 302 and swiveled 306 from the viewing area.

As shown in FIG. 4, the visual partition 202 can be moved away from the television screen 101. This may be advantageous when not using the television for gaming, but simply watching a show on the television.

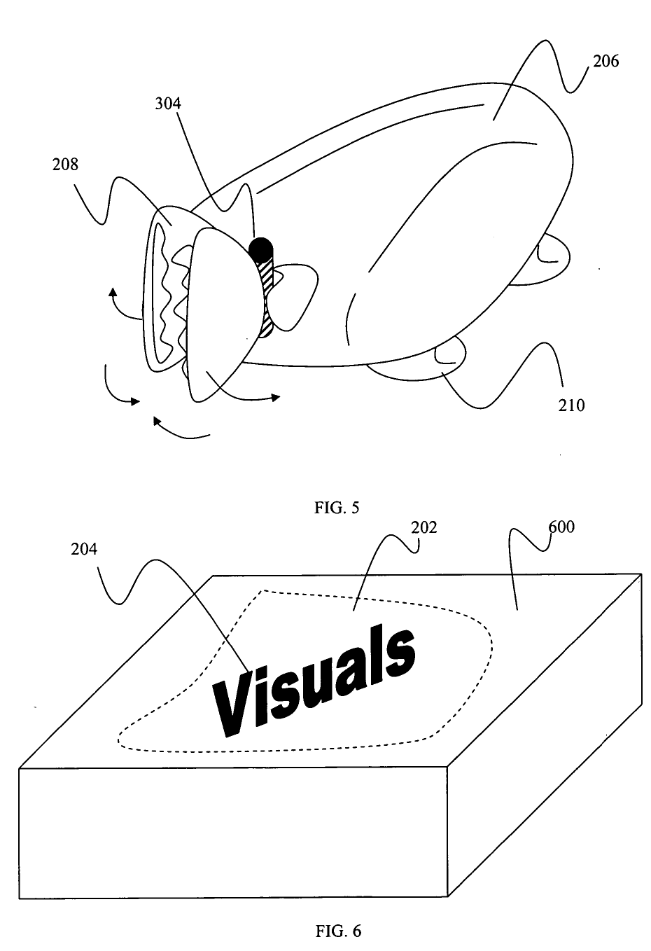

FIG. 5 illustrates another example of the base 206. As shown in FIG. 5, the holding apparatus 208 may be a clamp, with the swivel apparatus 304 being a pin. Additionally, the attachment apparatus 210 may be a suction cup.

As shown in FIG. 6, the visual partition 202 may be included along with a game system's packaging 600. In this embodiment, the visual partition 202 can be removed from the packaging 600 and used as the visual barrier 200 and its visual partition 202. Additionally, the visual partition 202 can include visuals 204. When in this embodiment, the visual partition 202 can be incorporate into the packaging 600 or separately included with the packaging 600. When incorporated into the packaging 600, it can be incorporated in any suitable manner, non-limiting examples of which include being perforated such that it can be easily cut out, or simply being present such that a user must cut it out. Alternatively, the visual partition 202 can be packaged and sold separately.

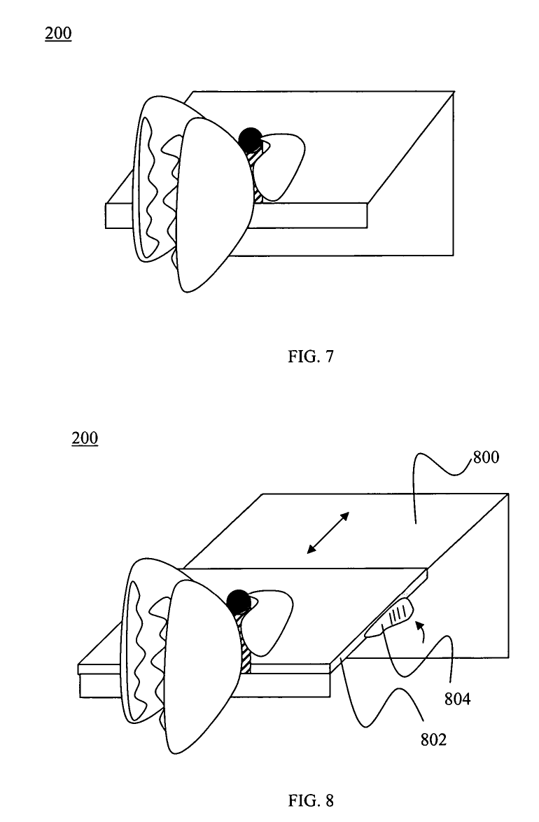

As shown in FIG. 7, because of the advent of flat screen televisions, the base 206 may come in a variety of configurations. For example, the base 206 may be formed in a shape such that it simply fits over the top edges of a flat screen television.

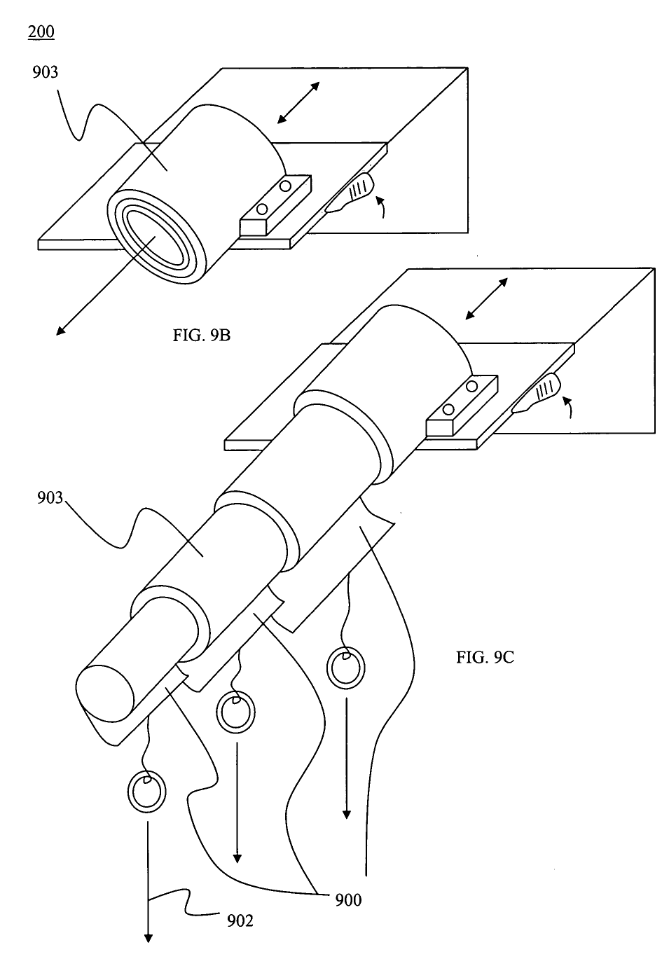

Alternatively, and as shown in FIG. 9, the base 206 may be adjustable. The adjustability allows the base 206 to be attached with televisions of varying widths. For example, the base may include a first clamping member 800 and a second clamping member 802. The two clamping members can be adjusted through an adjuster apparatus 804 to fit televisions of varying widths. The adjuster apparatus 804 is any suitable mechanism or apparatus for fixedly adjusting two objects, a non-limiting example of which includes a button that can be depressed to release pressure such that the two clamping members can be slid past each other to conform with the shape of the television. Upon releasing the button, the two clamping members become affixed with one another and consequently the base 206 becomes affixed with the television.

As shown in FIG. 9, the visual barrier 200 may include at least two pieces, where the visual partition 202 and the base 206 are substantially planar. In this configuration, both the visual partition 202 and the base 206 have slots 900 therein such that the two can be connected with each other through the slots 900. Both the visual partition 202 and the base 206 are constructed of any suitably rigid material, non-limiting examples of which include metal, plastic, and paperboard.

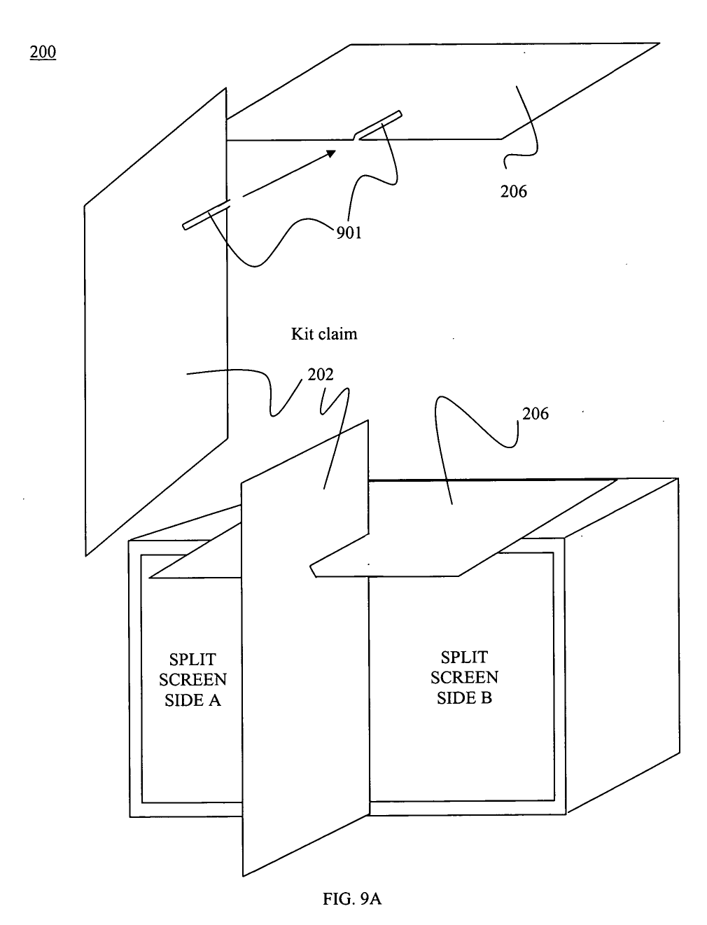

FIG. 8 illustrates another embodiment of the visual barrier 200. In this embodiment, the visual partition 202 is comprises of a plurality of extending members 800.

As shown in FIG. 9, the plurality of extending members 800 further include a plurality of extendable partitioning members 900, such that the plurality of extending members 800 can be extended from the base, with the plurality of extendable partitioning members 900 being extendable down therefrom. In this aspect, a user would pull out the extending members 800, and therafter pull down 902 the extendable partitioning members 900. Additionally, a retracting mechanism is included so that the extendable partitioning members 900 can return to their beginning position (i.e., before being pulled down 902).

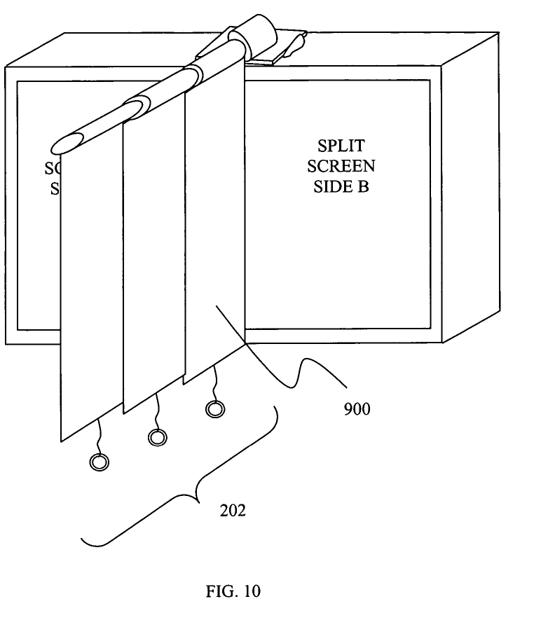

As shown in FIG. 10, the when the extendable partitioning members 900 are pulled down 902, they collectively form the visual partition 202.

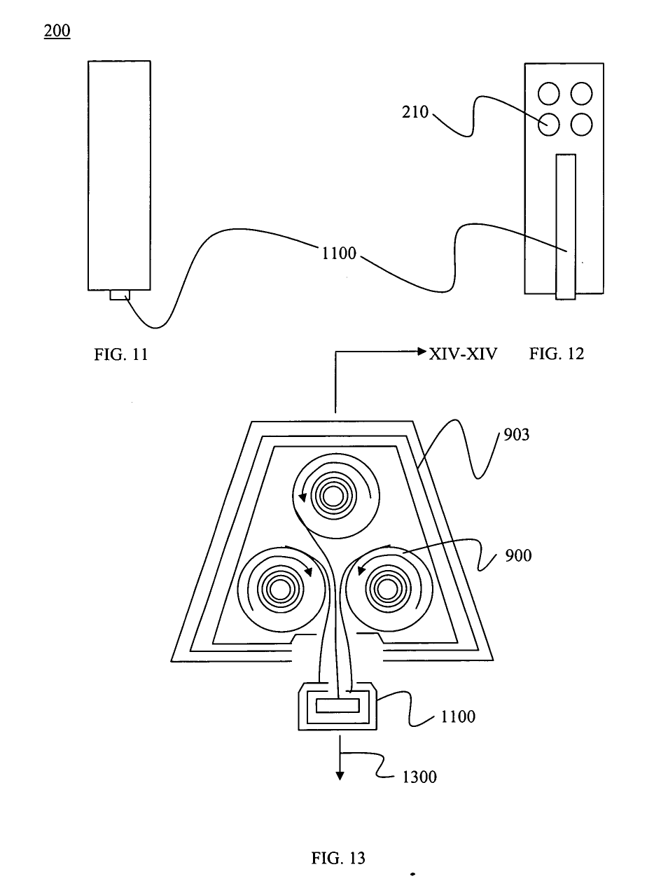

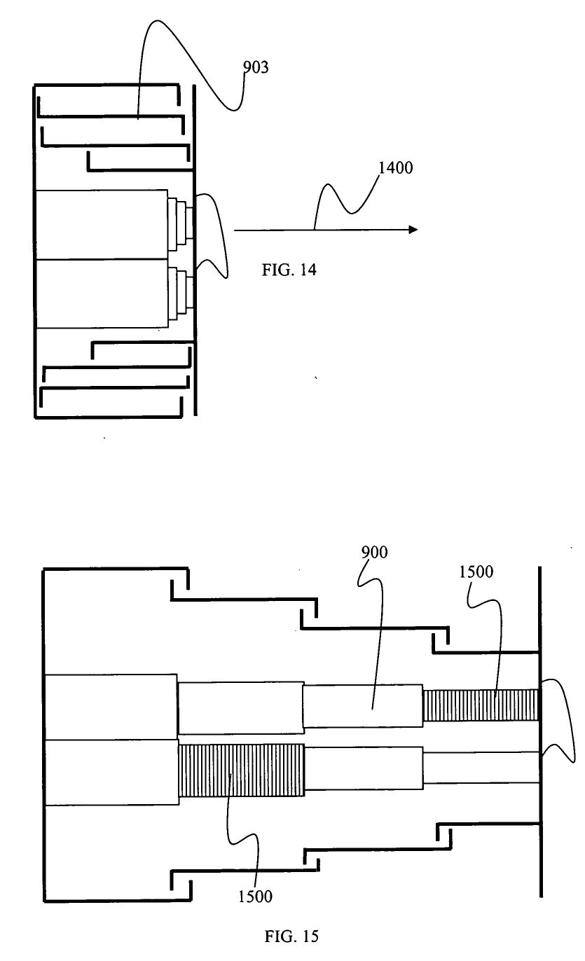

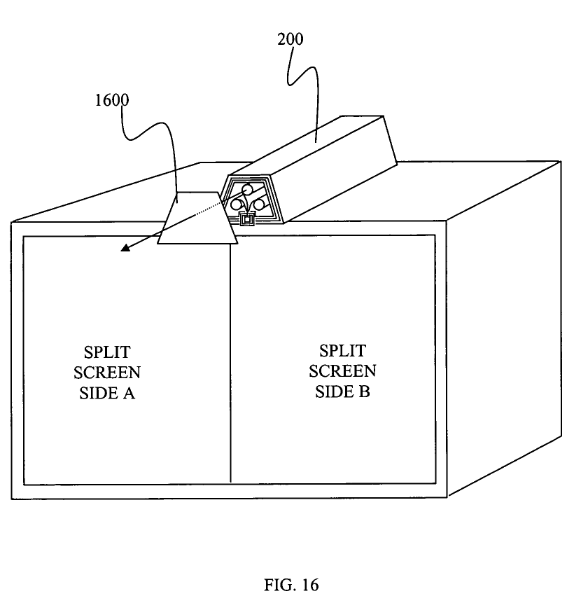

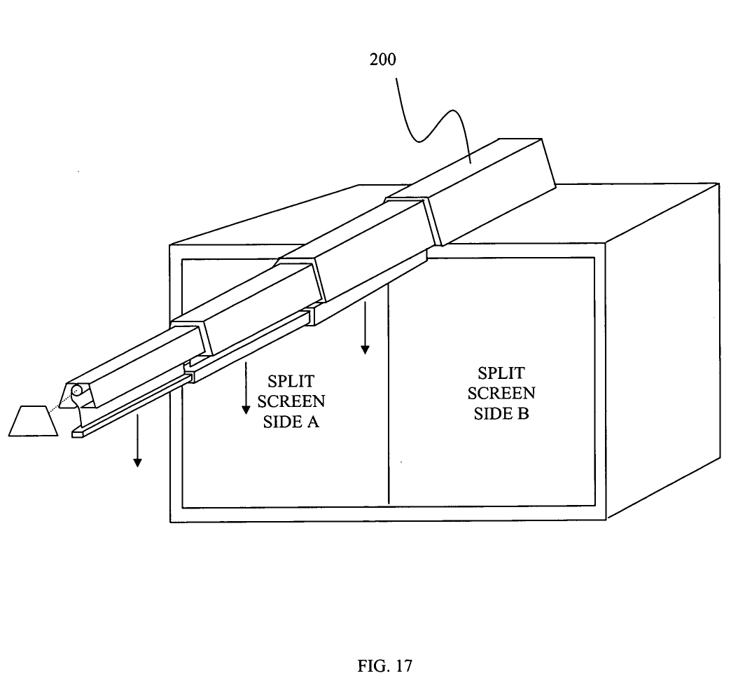

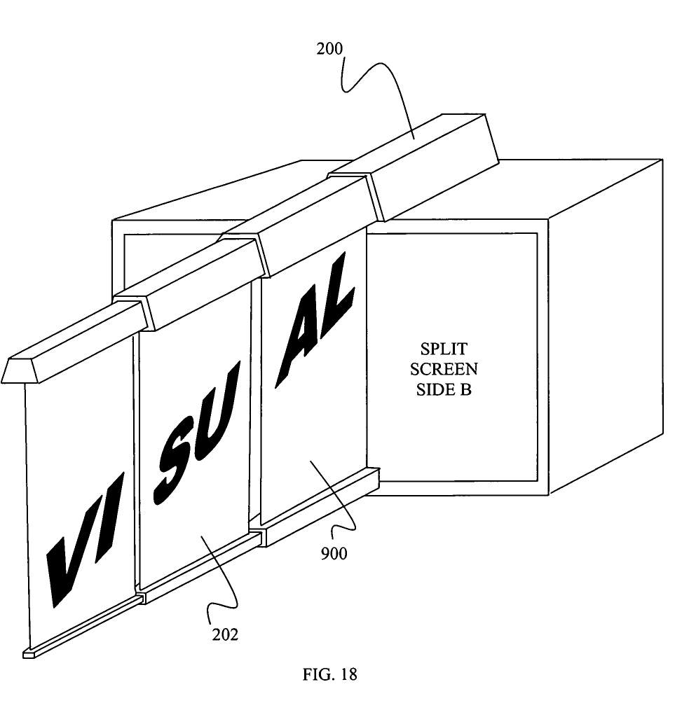

FIGS. 11-17 show an alternative embodiment of the visual barrier with extending members 800 and extendable partitioning members 900. FIG. 11 shows a top view of a visual barrier 200 with a pull tab 1100. The pull tab 1100 allows the internal mechanism to be retracted from the base (i.e., the extending members and the extendable partitioning members). FIG. 12 illustrates a bottom view of the visual barrier 200 of FIG. 11, with an attachment apparatus 210 and a pull down apparatus 1200. The pull down apparatus 1200 is any suitable mechanism for extending the extendable portioning members. For example, the pull down apparatus may be rod that is connected with the bottom portions of each extendable partitioning member. FIG. 13 illustrates a front cut-away view of the visual barrier 200 of FIG. 11. As shown in FIG. 13, the plurality of extending members 800 and the plurality of extendable partitioning members 900 are formed such that they can be extended and do not interfere with each other. Additionally, the pull down apparatus 1100 is attached in such a manner with the extendable partition members 900 that it can be pulled down 1300. Furthermore, the pull down apparatus includes a plurality of parts such that each part is connected with an individual extendable partitioning member 900. An advantage of such an embodiment is that it allows the visual barrier 200 to be expanded in both a horizontal and vertical manner (i.e., away from the television and downward to form a visual partition.) FIG. 14 illustrates a side cut-away view of the visual barrier of FIG. 11. As shown in FIG. 14, the plurality of extending members are configured such that they can be extended outward 1400, yet prevented from being pulling apart. FIG. 15 illustrates the visual barrier 200 of FIG. 11 in an extended position. As shown in FIG. 15, the extendable partitioning members 900 include a telescoping mechanism. The telescoping mechanism is formed such that the downward extendable portion 1500 of each extendable partitioning member 900 does not interfere with the downward extendable portion 1400 of other extendable partitioning members 900. FIG. 16 illustrates the visual barrier 200 of FIG. 11 attached with a television, with a front plate 1600 removed for illustrative purposes. FIG. 17 illustrates the visual barrier 200 of FIG. 11 in an extended position. FIG. 18 illustrates the visual barrier 200 of FIG. 11, with the extendable partitioning members 900 fully extended.

As shown in FIG. 18, the extendable partitioning members 900 collectively form the visual partition 202.

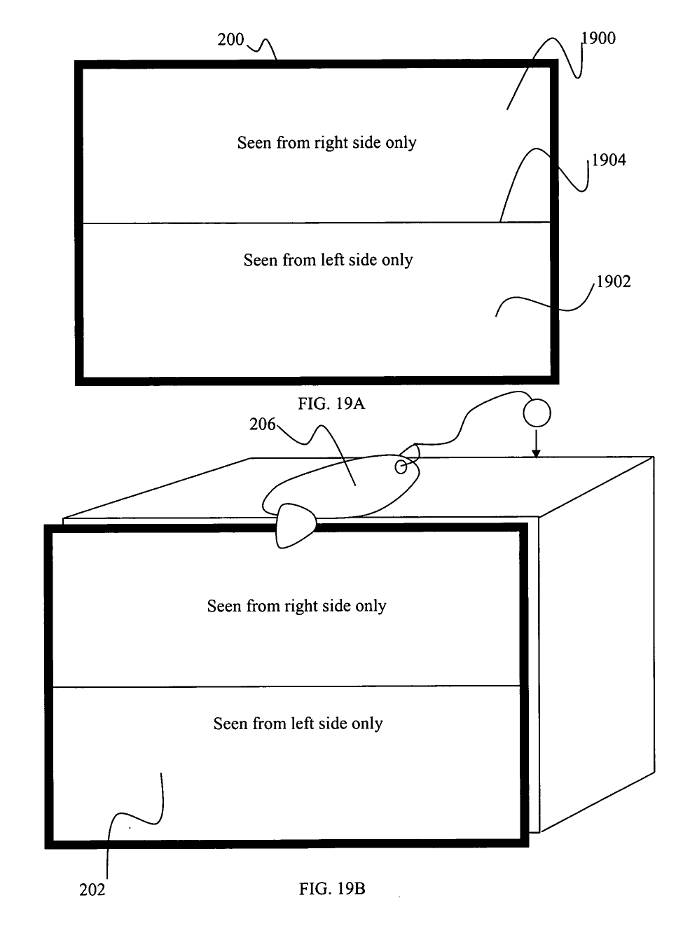

Many of the currently available multi-gamer games include split screens where the viewing area is split vertically. The previously described visual barriers are effective in splitting a viewing area of vertically split screens. However, not all multi-player video games split the screen vertically. In the alternative, some games split the screen horizontally, where the first gamer's playing screen is on the top, while the second gamer's playing screen is on the bottom. For such games, the visual barrier can simply be a polarized screen to be attached with a television. As shown in FIG. 19A, the visual barrier 200 can be a polarized screen, where the top portion 1900 includes a first plane of polarization, and the bottom portion 1902 includes a second plane of polarization. In such an embodiment the first plane of polarization is different than the second plane of polarization, such that a gamer sitting at one position will only be able to see either the top or the bottom of the television screen. This can be accomplished by using a different polarized screen for the top portion 1900 and the bottom portion 1900, with a middle partition 1904 holding the two screens together. The polarized screen can be formed of any material that allows for polarization, non-limiting examples of which include optical isomers. As shown in FIG. 19B, the polarized screen can be the visual partition 202, to be attached with a base 206, or any other technique for attaching the polarized screen with a television.

In another aspect, the polarized screen can be controlled with an electrical signal to shift the plane of polarization. In this aspect, a user can select their viewing angle by using the electrical signal to turn the optical isomers to the desired configuration.

What is claimed is:

1. A visual barrier for partitioning a viewing area of a television into at least two sides, comprising a visual partition, the visual partition being formed to attach with a television and to partition a viewing area of a television, whereby when attached with the television, the viewing area of the television is split into at least two sides.

2. A visual barrier as set forth in claim 1, further comprising a base attached with the visual partition.

3. A visual barrier as set forth in claim 2, wherein the base is formed to be attached with a television and to hold the visual barrier as a partition of the viewing area of the television.

4. A visual barrier as set forth in claim 3, wherein the base further comprises a holding apparatus to hold the visual partition.

5. A visual barrier as set forth in claim 4, wherein the base further comprises an extending apparatus, such that the visual partition can be extended away from the viewing area.

6. A visual barrier as set forth in claim 5, wherein the base further comprises a swivel apparatus, such that the visual partition can be extended away and swiveled from the viewing area.

7. A visual barrier as set forth in claim 6, wherein the base further comprises an attachment apparatus for attaching with a television.

8. A visual barrier as set forth in claim 7, wherein the attachment apparatus is selected from a group consisting of suction cups, clamps, Velcro, screws, glue, and counter weight.

9. A visual barrier as set forth in claim 8, wherein the visual partition further comprises visuals.

10. A visual barrier as set forth in claim 9, wherein the visuals are selected from a group consisting of advertisements, game relative visuals, instructions, and game tips.

11. A visual barrier as set forth in claim 10, wherein the visual partition is included along with a game system's packaging, such that the visual partition can be removed from the packaging and used as the visual barrier.

12. A visual barrier as set forth in claim 3, wherein both the visual partition and the base are substantially planar.

13. A visual barrier as set forth in claim 12, wherein both the visual partition and the base have slots therein such that the two can be connected with each other through the slots.

14. A visual barrier as set forth in claim 2, wherein the visual partition further comprises a plurality of extending members.

15. A visual barrier as set forth in claim 14, wherein the plurality of extending members further include a plurality of extendable partitioning members, such that the plurality of extending members can be extended from the base, with the plurality of partitioning members being extendable down therefrom.

16. A visual barrier as set forth in claim 1, wherein the visual partition is formed of a polarizing material and is formed such that the visual partition includes at least two planes of polarization, such that a first user aligned with a first plane of polarization can view a first gaming surface, while a second user aligned with a second plane of polarization can view a second gaming surface.

17. A visual barrier as set forth in claim 16, wherein the at least two planes of polarization are formed of optical isomers.

18. visual barrier as set forth in claim 2, wherein the base further comprises a holding apparatus to hold the visual partition.

19. A visual barrier as set forth in claim 2, wherein the base further comprises an extending apparatus, such that the visual partition can be extended away from the viewing area.

20. A visual barrier as set forth in claim 2, wherein the base further comprises a swivel apparatus, such that the visual partition can be extended away and swiveled from the viewing area.

21. A visual barrier for partitioning a viewing area of a television into at least two sides, comprising:
a base, the base being formed to be attached with a television;
a holding apparatus attached with the base for holding a visual partition;
a visual partition for attaching with the holding apparatus and for partitioning a viewing area of a television into at least two sides, whereby when the visual barrier is attached with the television, the viewing area of the television is split into at least two sides.
